(19) United States
(12) Patent Application Publication
(10) Pub. No.: US 2010/0100436 A1
(43) Pub. Date: Apr. 22, 2010

(54) METHOD AND SYSTEM FOR TRIGGERING AN AUTOMATED MAILER RESPONSE ACTION

(75) Inventors: Leondo R. PHIFER, Chicago Heights, IL (US); Walter S. Conard, Lake Villa, IL (US); Marvin L. Isles, Juneau, AK (US)

Correspondence Address: MCDERMOTT WILL & EMERY LLP, 600 13TH STREET, N.W., WASHINGTON, DC, 20005-3096, US

(73) Assignee: BOWE BELL + HOWELL COMPANY

(21) Appl. No.: 12/578,961

(22) Filed: Oct. 14, 2009

Related U.S. Application Data
(60) Provisional application No. 61/136,950, filed on Oct. 16, 2008.

(51) Int. Cl. G06Q 30/00; G06F 15/16

(52) U.S. Cl. 705/14.49; 709/206

(57) ABSTRACT

Systems, methods, and articles of manufacture that automatically invoke one or more marketing actions directed toward a mail target are shown and described. Real time mail stream event data for one or more mail items intended for the mail target are analyzed to determine when a pre-delivery event in the processing of the one or more mail items intended for delivery to the target through a mail delivery network occurs. When the pre-delivery event corresponds one of a number of pre-assigned triggering actions a command is issued to execute a marketing action associated with the detected triggering action.

### RELATED APPLICATIONS

This application claims the benefit of U.S. Provisional Application No. 61/136,950, filed Oct. 16, 2008, the disclosure of which is entirely incorporated herein by reference.

### TECHNICAL FIELD

The subject matter presented herein relates to a method and system for automating a marketing action in response to a mail item being processed through a mail delivery network.

### BACKGROUND

Companies invest millions of dollars on marketing campaigns designed to influence a target consumer's buying decisions. Whether by way of television, radio, internet or written correspondence, many such campaigns generally entail multiple sequentially timed messages, events or activities corresponding to a common theme of “buy this product/support this concept.” More sophisticated campaigns may employ a combination of communication mediums to reach their chosen targets, such as the placement of a follow-up call subsequent to the sending of a letter through the mail. Suffice to say, the effectiveness of such campaigns is heavily dependent upon the quantity, quality and timing of the actions to be performed. This is especially important in a day and age where the average consumer is bombarded with junk e-mail, pop-up window advertisements, telemarketing calls and other forms of advertising based communication aligned with a particular marketing strategy.

In the case of mail based correspondence, the mailer has limited control over the delivery of mail items destined for a particular target once the mail item is placed into the delivery network's mail stream. For example, in the case of the United States Postal Service (USPS), a mail item may flow through a plurality of destination entries positioned throughout the United States before ever reaching the addressee (target consumer). The various destination entries of the USPS network may include Bulk Mail Centers (BMCs), Sectional Center Facilities (SCFs), Destination Delivery Units (DDUs) and Destination Area Distribution Centers (DADCs). Each destination entry may process the mail item in different ways as it flows through the network, including validating it for compliance with postal authority design regulations, imaging it for delivery point verification, printing upon it, sequencing it for final delivery, scanning it to enable a general means of tracking by the mailer, etc. The extent to which the above described processes are performed depends on the mail type to be processed (e.g., first class, flats), the distance between the location of initial induction into the delivery network's mail stream and the final delivery point of the target, and the processing capabilities of respective destination entries within the postal network. Likewise, the extent to which a mail item can expect to arrive at the target may vary based on the same factors, as well as with respect to environmental or infrastructure challenges respective to the delivery network. Consequently, further marketing actions to be performed based upon the mail correspondence are affected.

Current day methods for coordinating marketing actions in association with mail correspondence rely upon “historical” or “predictive” models and approaches. For instance, the historical approach entails accumulation of past delivery data pertaining to the target in question as an indicator of current day mail stream behavior. With this approach, historical data regarding dates of delivery network mail stream induction, tracking dates (e.g., USPS) and other events that occur during mail stream processing are employed to determine an average or best guess estimation of mail item delivery. Using this historical data, the mailer may at least identify a range of possibilities for which to base subsequent or related marketing efforts. Similarly, the predictive approach relies on historical data, as well as other factors pertaining to the target in question, as a means to discern future behavior of the target with respect to the mail item sent.

While both approaches are not without merit, neither the historical or predictive model leverage real-time mail stream event data—particularly those events which occur prior to receipt of the mail item by the target (intended recipient)—as a means of invoking a marketing action. Rather, both rely on averages comprised of the aggregation of past mail stream data and statistics. Indeed, such approaches are not sufficient to account for real-time variations that inevitably occur when a mail item enters the delivery network's mail stream, and especially, those processing events indicative of the mail item's status just prior to delivery to the target. Thus, an improved system and method to account for such real-time variations is needed in the art.

### SUMMARY

The teachings herein alleviate one or more of the above noted problems by providing a method for automatically invoking one or more marketing actions associated with a mail target. The method includes activating one or more executable scripts having instructions for conveying or initiating a marketing action in association with the mail target. One or more triggers is associated with the one or more executable scripts based on defined events pertaining to processing of a mail item within a delivery network mail stream. A mail item intended for the mail target is submitted to a delivery network. The mail item has an identifier such as a barcode printed thereon suitable for processing by the delivery network. Event data pertaining to the mail item is received as it is processed by the delivery network in association with the barcode or the like identifier. The executable script(s) is/are triggered in response to the occurrence of a defined event.

In certain examples, the executable script conveys instructions for executing an e-mail message, a robotic call, a text message, a facsimile, an internet based communication/advertisement corresponding to the mail correspondence, generation of a written letter, a machine control message (e.g., a message to the inserter that inserters for the target need to be changed, auto-print message), a salesperson dispatch call, etc. The defined events can occur before or after delivery of the mail item to the target.

In one instance, for example a method of automatically invoking one or more marketing actions directed toward a mail target is shown and described. The method can include receiving, at a response controller over a communications network interface, real time mail stream event data for one or more mail items intended for the mail target and analyzing, by the response controller, the received real-time mail stream event data to detect when a pre-delivery event in the processing of the one or more mail items intended for delivery to the target through a mail delivery network corresponds one of a number of pre-assigned triggering actions. The method can also include issuing a command to execute a marketing action associated with the detected triggering action. The event data for each respective mail item intended for the target represents one or more events in processing of the respective mail item as it progresses through a mail delivery network prior to delivery to the mail target.

In some instances, the method also includes executing the marketing action in response to the receipt of the command. The marketing action can be executed in one or more marketing channels. The marketing action can be selected from the group consisting of transmitting an e-mail message, making a robotic call, transmitting a multimedia messaging message, transmitting a facsimile, generating of a written letter, issuing a machine control message to a mail preparation machine, and executing a salesperson dispatch call.

Also, the method can include comprising customizing the marketing action in response to customer relationship management data associated with the one or more mail targets. The method can also include modifying at least one of the pre-assigned triggering actions responsive to customer relationship management data associated with the one or more mail targets.

In some instances, the method includes associating one or more triggering actions with one or more mail items using a unique identifier for each mail item to generate the pre-assigned triggering actions and storing the pre-assigned triggering actions in a database in communication with the response controller. In some cases, issuing a command to execute a marketing action includes issuing a command to begin the execution of a scripted marketing action that is associated with the mail target.

Also, analyzing can include analyzing the received real-time mail stream event data to detect when a final event prior to delivery occurs. Further, the real-time mail stream event data can include at least one of a start-the-clock event, a delivery carrier sequencing event, and an interim processing event.

In another instance, for example, an article of manufacture having a machine readable storage medium and executable program instructions stored on the medium are shown and described. When the medium is when executed by a programmable system in communication with a mail delivery network, the instructions cause the system to perform functions that automatically invoke one or more marketing actions associated with a mail target. The functions can include receiving, at a response controller over a communications network interface, real time mail stream event data for one or more mail items intended for the mail target and analyzing, by the response controller, the received real-time mail stream event data to detect when a pre-delivery event in the processing of the one or more mail items intended for delivery to the target through a mail delivery network corresponds one of a number of pre-assigned triggering actions. The functions can also include issuing a command to execute a marketing action associated with the detected triggering action. The event data for each respective mail item intended for the target represents one or more events in processing of the respective mail item as it progresses through a mail delivery network prior to delivery to the mail target.

In another instance, for example, a system for automatically invoking one or more marketing actions associated with a mail target is shown and described. The system includes a database and a response controller. The database stores one or more triggering actions, the one or more triggering actions each being associated with one or more mail targets and one or more marketing actions. The response controller is in communication with the database. The response controller includes a receiver module and a processor. The receiver module receives real-time mail stream event data for each respective mail item intended for the target representing one or more events in processing of the respective mail item as it progresses through a mail delivery network prior to delivery to the mail target. The processor analyzes the received real-time mail stream event data to detect when a pre-delivery event in the processing of a mail item intended for delivery to the target through a mail delivery network corresponds one of a number of pre-assigned triggering actions and issues a command to execute the at least one marketing action associated with a respective triggering action.

In some instances, the system includes a customer relationship management database in communication with the response controller, wherein the processor customizes the marketing action in response to customer relationship management data associated with the one or more mail targets. The system can also include a customer relationship management database in communication with the response controller, wherein the processor modifies the one or more pre-assigned triggering actions stored in the database in response to customer relationship management data associated with the one or more mail targets.

The system can also include, in some examples, an assignment module in communication with the database, the assignment module facilitating the association of the one or more marketing events with the one or more pre-assigned triggering actions. The assignment module can also facilitate the association of the one or more pre-assigned triggering actions with the mail target.

In some instances, the processor executes the marketing action. The marketing action can be is selected from the group consisting of transmitting an e-mail message, making a robotic call, transmitting a multimedia messaging message, transmitting a facsimile, generating of a written letter, issuing a machine control message to a mail preparation machine, and executing a salesperson dispatch call. The marketing action can also be script of actions that are executed by the processor.

In some instances, the pre-delivery event includes a final event prior to delivery of the mail item to the target. Also, the real-time mail stream event data can include at least one of a start-the-clock event, a delivery carrier sequencing event, and an interim processing event.

The advantages and novel features are set forth in part in the description which follows, and in part will become apparent to those skilled in the art upon examination of the following and the accompanying drawings or may be learned by production or operation of the examples. The advantages of the present teachings may be realized and attained by practice or use of the methodologies, instrumentalities and combinations described herein.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 depicts an exemplary high-level system for invoking one or more marketing actions based on real-time mail stream event data.

FIG. 2 is exemplary flowchart depicting the logical steps employed for invoking one or more marketing actions based on real-time mail stream event data.

FIG. 3a depicts exemplary data, including that for a unique mail item identifier capable of being associated with a mail item destined for a postal sort group.

FIG. 3b depicts a barcode identifier based on the exemplary data containing the unique mail item identifier.

FIG. 4 illustrates a network or host computer platform, as may typically be used to implement a server.

FIG. 5 depicts a computer with user interface elements.

### DETAILED DESCRIPTION

The teachings presented herein pertain to a system and method for invoking one or more marketing actions based on real-time delivery network mail stream event data. As used herein, a “mail stream” refers to the influx of items—physical and digital mail, documents and packages—across a mail delivery network to at least one intended recipient (target). Various private and public mail delivery networks, such as the United States Postal Service (USPS) or Federal Express, may perform differing mail stream processing techniques and workflow procedures to meet delivery needs of their customers based on their respective processing capabilities, including but not limited to: delivery of mail items, induction of mail items, sorting of mail items, printing onto mail items, validation of addresses as printed onto mail items, verification of mail item design requirements, scanning or mail items and other procedures. With respect to the techniques presented herein, any mail item capable of processing by the mail delivery network or an agent thereof within the context of the mail delivery network is considered a part of the delivery network mail stream.

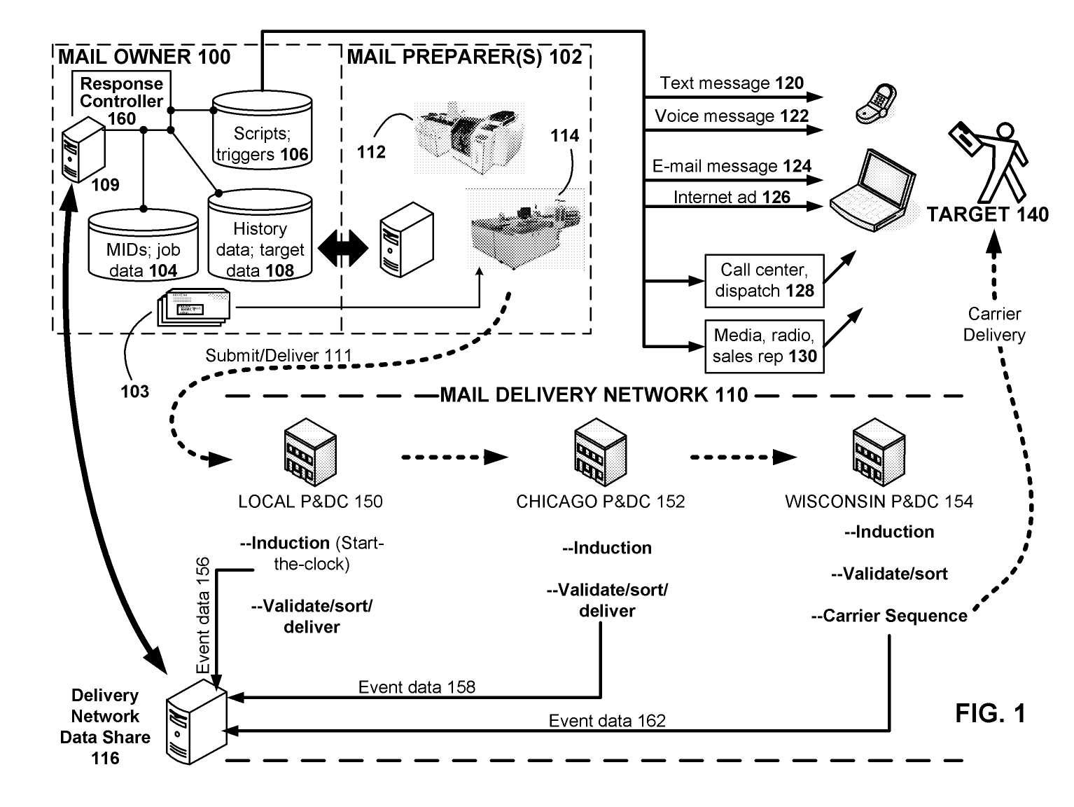

Also, as used herein, a “marketing action” refers to one or more instructions, rules, tasks, activities or interactions performed for or by a marketer (e.g., mail owner) or agent thereof (e.g., mail preparer) to elicit a desired response or behavior from a target. As the marketing action may comprise one or more of the aforementioned activities, each may be coordinated in accord with a marketing strategy directed to elicit said response. An exemplary desired behavior or response on the part of the target—that indicative of favorable response or acceptance of the mailed solicitation—may include, but is not limited to: logging onto a website, activating a credit card, account, product or service, returning an enclosed return envelope, calling an affiliated call or service center, performing a registration process or any other actions. As discussed in greater detail with respect to FIG. 1, the marketing action performed by the marketer or agent thereof to elicit such a response may take various forms. Specifically, FIG. 1 depicts an exemplary high-level system for invoking or executing one or more marketing actions based on real-time mail stream event data pertaining to a mail item directed at a particular target. In the exemplary figure, the marketer, agent thereof and target are a mail owner 100, mail preparer 102 and target 140, respectively. Of course, those skilled in the art will recognize that the mail owner 100 and mail preparer 102 may be one and the same, such as in the case of a captive mail shop or the like, capable of performing its own mail generation and processing tasks.

In general, the mail owner 100 is responsible for identifying, gathering or coordinating the instructions and/or data pertaining to one or more targets 140 to which mail items 103 are to be directed via a mail delivery network 110. As such, the mail owner possesses data regarding the one or more targets, including but not limited to: address and phone contact information, account status, detail and history detail, security data, transaction history, purchasing profiles, membership or enrollment details, etc. Of course, the type of information maintained will vary depending on the specific requirements or nature of the relationship between the target and the mail owner 100. Those skilled in the art will recognize that various Customer Relationship Management (CRM), contact management and other database driven tools are employed for maintaining data of this nature respective to one or more targets.

The mail owner 100 makes the original decision as to which targets their mail items are to ultimately be directed (e.g., the mailing list). In the case of a “captive mailer,” the mail owner 100 actively generates their own mailing for distribution via the mail delivery network 110; oftentimes employing mail delivery network certified software tools and data to ensure proper usage and application of addresses, barcodes (e.g., PLANET, POSTNET, Intelligent Mail Barcode), etc. Alternatively, the mail owner 100 may outsource the mail generation and preparation tasks to a mail preparer 102 (e.g., Letter Shop or Sort Processing Service Provider) that employs various inserters 112, sorters 114 and/or other document processing equipment to generate and/or organize mail. Whether captive or outsourced, the mail items are generally required to convey some form of unique identification approved by a postal authority or other mail delivery network that links them to their mailing. This identification must be expressly specified by the mail owner 100 once assigned (e.g., by a postal authority), such as via a mail owner identification (MID) database 104 containing all assigned MIDs. In other cases, the identification may be specified expressly by the mail preparer 102 as assigned also by the postal authority or other mail delivery network. Resultantly, the mail items will bear one or more address components or delivery point identifiers (e.g. ZIP Codes) corresponding to the delivery location of the target 140.

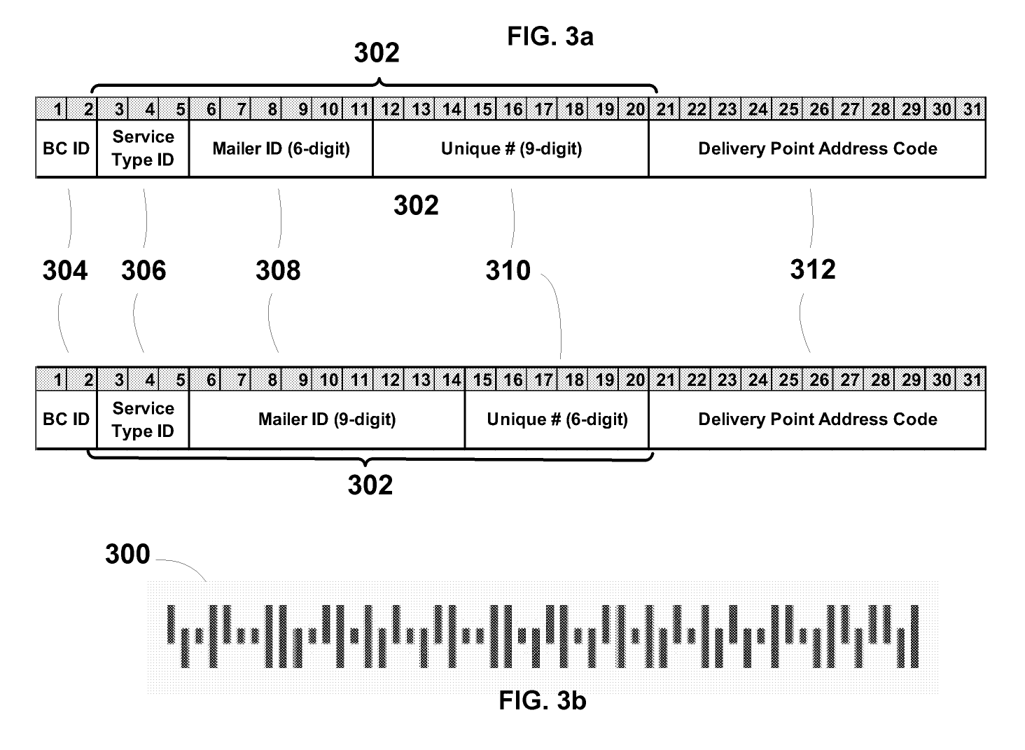

To facilitate the tracking of mail items displaying various delivery point identifiers as they are generated and/or processed by the mail owner 100 or preparer 102, ultimately for advancement through a mail delivery network 110, a convenient tracking means is required. More specifically, the tracking means must be unique and remain so for a given period of time as established by the postal authority or mail delivery network. FIGS. 3a-3b depict an exemplary postal authority approved code in the form of a barcode that allows for such tracking of mail items destined for placement within a particular postal authority or mail delivery network's mail stream. In particular, the exemplary barcode structure and type presented herein pertain to the Intelligent Mail Barcode (IMB) 300. Nonetheless, those skilled in the art will recognize that the IMB 300 is an exemplary postal authority approved code and does not limit the scope and application of the techniques and concepts presented herein. Furthermore, though presented herein with respect to a postal authority (e.g., USPS), the exemplary techniques described may be applicable to any mail item delivery service or delivery network that may benefit from schemes to enable appropriate mail identification uniqueness. Indeed, any type of postal code, be it barcode based, alpha-numeric, graphical or other may be employed within the context of the examples herein.

The IMB 300 is a height modulated barcode that uses varying vertical bar types to encode data as shown in FIG. 3A. When used to qualify for automation discounts, the IMB can be placed in the address block or in the barcode clear zone, generally found on the lower right corner of a mail item. The IMB 300 is a 31-digit postal authority code, with fields for encapsulating various data as shown in FIG. 3A. As recognized by those skilled in the art, various barcode generation software tools, fonts and/or encoders may be used to generate the IMB in accord with postal authority requirements. Data fields comprising the IMB 300 include, but are not necessarily limited to: a two-digit barcode identifier 304, a three-digit service type identifier 306, a six or nine-digit mailer identifier 308 (MID), a nine or six-digit unique number 310, and a delivery point address code 312 that can be zero, five, nine or eleven-digits. The MID 308 when taken in combination with the unique number 310 and service type identifier 306 comprise a 18-digit Unique Identifier 302.

The mailer ID (MID) 308 is generally defined and/or assigned by the postal authority based on the mailer's annual mail volume or other criteria. Generally, all 6-digit MIDs will begin with ‘0’ through ‘8’, while all 9-digit MIDs begin with ‘9’. The service type identifier 306 specifies a particular postal authority approved mail class and service(s) to be executed upon the mail item, such as First Class, Standard Mail, Periodicals, etc in the case of the United States Postal Service (USPS). The delivery point address code 312 contains ZIP Code data of varying ranges (e.g., 5-digit ZIP versus 11-digit ZIP). The unique number 310 may be assigned at the discretion of the mailer, but must be certifiably unique for a period of time specified by the postal authority (e.g., 45 days for USPS). Various techniques for determining the uniqueness may be employed by the mailer for encoding as the unique number 310, including but not limited to: serializing the mail items, embedding Julian date parameters, embedding mailing event data, using recipient identifier data, using database or mailing record ID. Those skilled in the art will recognize however that such ‘static’ encoding techniques are limited in their usefulness considering the dynamic nature of mail processing, particularly within a single multiple document processing device environment; where a particular clients' mailing may be distributed across differing devices.

While various other details regarding the IMB may be emphasized, the discussion will proceed to FIG. 3, which presents an exemplary flowchart depicting the process by which the unique numbers may be allocated and assigned within a multiple document processing system environment to ensure uniqueness of mail items for a specified period of time. More specifically, the assigned unique number may be encoded within a postal authority code, such as the IMB, on the basis of a 6 or 9-digit mailer identifier 308. Again, those skilled in the art will recognize that the IMB is only one of several types of present day and future postal authority code implementations suited for this purpose.

Turning again to FIG. 1, in accord with the exemplary teachings herein, the mail owner 100 and/or mail preparer 102 also maintains other data pertinent to the processing of mail items through the mail delivery network 110. For example, the mail owner 100 may maintain a database 104 of job data indicative of specific requirements relative to the mail items to be produced, including but not limited to, print instructions, fold and insert requirements, sort instructions, mail induction and delivery requirements, pallet scheme data, etc. The mail preparer 102 may provide job data necessary for enabling processing of mail items by the one or more document processing devices 112 and 114. Said job data may include, but is not limited to information, rules, policies and instructions that facilitate proper use and execution of the one or more mail processing devices 112 and 114, operator scheduling information, material/inventory data and other workflow management related information relevant to the mail preparer 102.

Still further, the mail owner 100 may supply the necessary target data (list data) 108 suitable for enabling the processing and delivery of mail items. Data of this nature may include, but is not limited to, target name and/or alias data, address and ZIP Code data, suite and/or apartment information, etc. History data relevant to a target 140 may also be maintained within a database—i.e., managed via a CRM system—such as data indicative of the target's 140 past response patterns with respect to previous mail correspondence from the mail owner 100. Exemplary historical data may include, but is not limited to, an average or past date of payment responsive to a billing notice, an average or past post-delivery call, an average or past website login time or an average or past time elapsed for return mail receipt responsive to a product offer.

Along with the target data and the history data in 108, the mail owner 100 also maintains one or more executable scripts 106 having instructions for conveying or initiating a script-based and/or prompted marketing action (executable marketing script) in association with a given target 140. Exemplary marketing actions conveyed or initiated by way of one or more executable scripts may include, but are not limited to: a text message 120 or voice message (e.g., robo-call) 122 conveying a marketing message, an e-mail message 124 conveying a marketing message, a targeted web advertisement 126 (e.g., cookie invocation) conveying a marketing message, a notification or prompting of a call center or sales dispatch service 128 associated with the mail owner 100, a notification or prompting of a media, radio or other advertising channel 130 associated with the mail owner 100. The scripts may be tailored specifically to the target, such as based on history data or target data 108 related to the target 140, and implemented (e.g., developed, scripted) with respect to varying marketing mediums. Those skilled in the art will recognize that the executable marketing script performed may directly initiate execution or prompting of a desired marketing action in accord with an overall marketing strategy or campaign to which the target 140 is the subject.

Alternatively, the scripts 106 may be implemented to generate or convey a marketing action of a generic form, so that it may be directed at multiple targets. In this way, the script may call upon the target data or history data in database 104 for data pertinent to a particular target such as the target's name, address, last date and product of purchase, birthday, hobbies or other interests. As various communication mediums may be employed to carry out the script-based marketing action, implementation approaches may vary. For instance, a script for prompting the execution of or directly facilitating a marketing action over a voice communication medium may differ in programming style or content than a script to enable a web-based communication. Nonetheless, those skilled in the art will recognize that various programming techniques, communication standards and software development processes may be employed for enabling suitable script execution over varying communication mediums and networks.

In some instances, the marketing action facilitated by way of script may simply be the generation of a notification or a prompt to a particular marketing channel 128/130 operating on behalf of or in conjunction with the mail owner 100. Again, the notification or prompt may itself be in the form of a text message 120, voice message 122, e-mail message 124 or even a real-time signal. In the latter scenario, the real-time signal may be in the form of a flashing indicator, a sound or other means—real-time capability resulting from communication between the mail owner 100 and the marketing channel in question. Upon prompt or notification, the corresponding marketing channel 128/130 may further commence the marketing action responsive to the prompt on behalf of the mail owner 100. Exemplary marketing actions performed via the execution of one or more scripts may include those described with respect to 120-126, dispatching or calling of a sales representative proximate to the location of the target 140, placement of a call by a call center representative alerting the target of the pending delivery of the mail item, scheduling of a radio advertisement to be aired in association with the mail item or target 140, etc. As an additional consideration, the scripts may themselves be executed based conditionally. So, for example, a particular script intended for a primary target (e.g., the leader of a particular organization) 140 may be delayed until an associated event occurrence with respect to other targets (e.g., the primary target's 140 subordinates) are detected. Ultimately, those skilled in the art will recognize that various means, styles and types of marketing actions may be performed and/or facilitated and that those presented herein are exemplary in nature only.

In association with the executable scripts are one or more event based triggers. The triggers are defined as conditions, which upon being met invoke the execution of the one or more associated scripts by a response controller 160. The response controller 160 may be implemented as an executable module by way of software, hardware or a combination thereof, that features but is not limited to performance of the following: executable instructions for defining, enabling and loading one or more event triggers in association with a given or selected script such as from database 106 or other source, executable instructions for accessing, retrieving or querying event based data regarding a mail item such as from a delivery network data share 116 as provided by the mail delivery network or other source of mail stream data, a local or remote graphical user interface accessible to the owner 100 and/or mail preparer 102 for enabling execution of such features, etc. Skilled artisans will recognize that various means for implementing the response controller 160 may be performed and that the specific examples set forth herein are not meant to limit the scope of the invention.

In particular, the response controller 160 enables the mail owner 100 to select and/or define the event based triggers pertaining to those events that occur during processing of a particular mail item within the mail delivery network 110—i.e., as it is processed through the delivery network mail stream with the intent to be delivered to a target 140. Processing events that occur as the mail item moves through the delivery network mail stream 110 may include, but is not limited to, validating the mail item for compliance with postal authority design regulations, imaging it to conduct delivery point verification, printing upon it (e.g., address forwarding, sort instructions, mail status), scanning it to record pertinent data that enables a general means of tracking by the mailer, sequencing it for final delivery, maintaining records of the aforementioned transactions by event code designation to a data share system 116, etc. Of particular interest may be any event data that indicates the point of induction of the mail item within the mail delivery network 110, the point of final arrangement of delivery of mail items to the mail target 140 or that indicative of a particular machine type upon which it is being processed as the aforementioned transactions occur, etc. Indeed, any event data that may be accumulated and conveyed to the mailer 100 or other interested party during processing of the postal authority approved code(s) as printed on the mail item; processed via one or more imaging, reading or other mail item identification detection devices, may be employed as an event trigger. Resultantly, the event data (i.e., formulated as metadata) conveyed to or retrieved by the response controller 160 in connection with processing of a postal authority approved code of a mail item is suitable for invoking the execution of a corresponding script.

In particular, a mail owner 100 or agent thereof (mail preparer 102) would establish (select from a pre-existing set or define anew) the event triggers via the response controller 160 along with the associated script(s) to be run based on said event triggers; this establishment occuring prior to entry of the mail item into the mail delivery network 110. For instance, a graphical user interface (not shown) of the response controller 160 may feature various drop-down menus and/or check boxes for selecting pre-existing/known/typical mail processing events to associate with a particular script. Alternatively, the mail owner 100 may define a custom event type to be associated with a particular script, complete with a description of the event data type (e.g., metadata) to be defined by this particular trigger, an event code corresponding to that event type or other data which may be provided by the delivery network's data share 116. Even still, it is feasible that event data pertinent to post delivery conditions may also be employed as a trigger, and hence defined by the response controller 160.

Once complete, the mail items are delivered or submitted to the mail delivery network 111, wherein they eventually enter the mail delivery network 110 to be processed through the delivery network's mail stream. The mail item flows through the network 110 from one mail processing facility 150-154 or stage to the next undergoing various types of processing one or more mail processing devices, each event or transactional occurrence 156, 158 or 162 undertaken being suitable for definition of an event based trigger. Events or transactions 156, 158 or 162 that may occur may include but is not limited to: validating the transmitted mail item for compliance with postal authority design regulations and barcode quality requirements (e.g., USPS MERLIN™ compliance), orienting it for enabling postage reconciliation and verification, imaging it for performing address validation and delivery point verification (e.g., in accord with USPS CASS requirements), printing upon it by one or more printers, sequencing it for final delivery, scanning it to enable a general means of tracking by the mailer, etc. The aforementioned processing events may be performed by one or more automation devices operable within the mail delivery network, including but not limited to: Delivery Bar Code Sorters (DBCS), Carrier Sequence Bar Code Sorters (SCBCS), Mail Processing Bar Code Sorters, Multi-line Optical Character Readers, Advanced Facer Canceller System, printers, etc. As each mail item is processed in the above described ways respective to its printed barcode or other unique identification by the above described devices, event data 156 (e.g., induction, start-the-clock), 158 (e.g., interim processing events such as validation, tracking) or 162 (e.g., carrier route sequencing) pertaining to the barcode and hence mail item at that point in process may be conveyed to a data storage device 116. Indeed, the event data 156, 158 or 162 conveyed as the mail item is transported from one mail processing stage, machine, facility 150-154, etc. to the next will feature varying condition codes, time tags and metadata respectively.

Particularly with respect to the USPS, the event data pertaining to mail items in process may be captured and logged in near real-time so as to make the data available to the mail owner or another interested party. For example, in the case of the Intelligent Mail Barcode (IMB), event data indicating when and where a mail item is initially inducted into a mail delivery network's network 110 is provided as “start-the-clock” data. Still further, mail item data may be conveyed as one or more time tagged event codes indicative of the processing status of a mail item such as the date and time it was attempted for delivery, refused for delivery, returned to sender or forwarded. Other event data such as the date, time, machine identification and location of carrier route sequencing of the mail item, date, time and location of subsequent destination entry induction of the mail item and other data pertaining to processing events collected prior to delivery may also be logged and conveyed with respect to the uniquely applied IMB or other identifier. In some cases, the event data collected to the data share 116 may be conveyed to the response control 160 operating in connection with the mail owner directly by the mail delivery network (e.g., published to a secure web page or e-mailed). Alternatively, the event data 156-160 may be queried by the response controller 160 operating on behalf of the mail owner 100 via known data mining and extraction techniques. Event data 156-160 as described above may be gathered by way of various automation devices, imaging devices, scanning devices, verification systems and other data gathering, reading and interpretation means operable within the mail delivery network 110.

In regards to the teachings presented, a skilled artisan will recognize that the various actions described above with respect to the mail owner 100 may also be carried out by the mail preparer 102 on behalf of the owner 100. Hence, in the aforementioned paragraphs respective to FIG. 1, the actions and intentions of the mail owner 100 may be synonymous with that of the mail preparer 102. Indeed, the various databases 104-108 may be shared by the mail owner 100 and mail preparer 102 via a suitable shared database configuration and network communication means. Likewise, databases 104-108 may be implemented in a distributed fashion as opposed to a centralized manner respective to a single computing device 109 as depicted. Regardless of implementation, computing device 109 may have executable thereon or be in communication with, a response controller 160. As mentioned above, the response controller 160 enables execution of one or more select scripts 106 upon detection of an associated event trigger. Consequently, the response controller 160 may also access the various data sets 104-108.

Also, where a marketing channel 128/130 is employed to execute a specified marketing action in response to an event based notification, the marketing channel 128/130 may also access the appropriate databases 104-108 required for execution of the action. In such a case, the marketing channel may employ or access the response controller 160, such that it is configured to have the same event based triggers defined to enable a desired response. Or alternatively, the marketing channel 128/130 may execute various other scripts approved for use by the mail owner 100 relative to a particular mail item (or group thereof). So, for example, a call center for a credit card agency may alert an account manager to place a call to a customer in response to a start-the-clock event occurrence, such as to verbally communicate a credit terms for that account in accordance with Unfair and Deceptive Acts or Practices (UDAP) rules. Ultimately, the scripts whether executable as prompt or as medium of communication directly enables a means of coordinated and timed marketing actions to be executed as the mail item is processed for eventual delivery to the target 140.

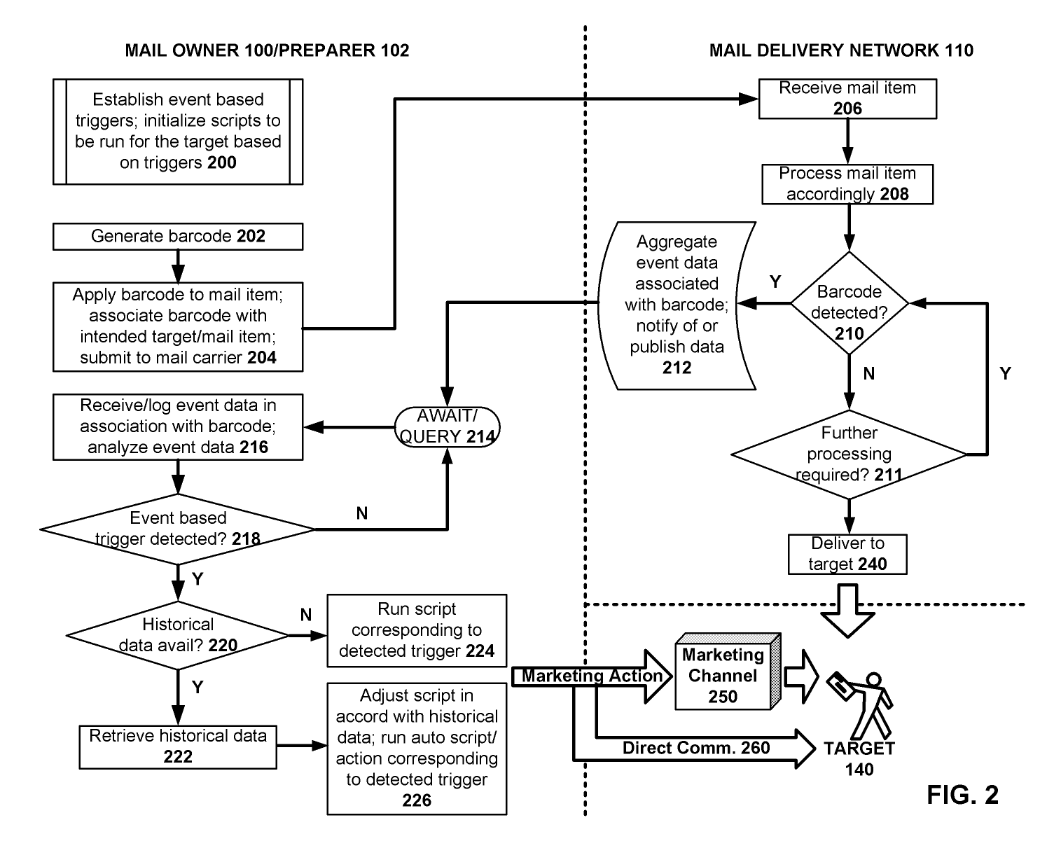

Turning now to FIG. 2, an exemplary flowchart depicting the logical steps employed for invoking one or more executable marketing scripts based on real-time mail stream processing event data is presented. As described previously, the mail owner 100 or preparer 102 establishes the various event based triggers to be associated with a particular mail item. Generally, the triggers are established (selected or defined)—i.e., via the response controller 160—prior to generation or distribution of the mail item to the mail delivery network. However, there may be instances wherein such triggers are set and initiated after the mail item enters the mail delivery network 110. In addition, the mail owner 100 or preparer 102 may initialize the associated scripts to be run for the target based on the trigger points (event 200)—i.e., via the response controller 160. Initialization of the scripts via graphical user interface access to the response controller 160 may include selecting and then loading the appropriate scripts into a queue, such as in accord with a marketing sequence or strategy.

As the mail item is generated, it will feature various address components and/or delivery point identifiers, such as an approved barcode like the IMB. The applied barcode will be associated with the mail item to which it is applied (event 202) and hence the intended target, such as via maintenance of a reference database by the mail owner 100 or preparer 102. In this way, the barcode may be readily identified by the mail owner 100 or preparer 102 in association with the target 140 upon submission of the mail item to the mail delivery network 110 (event 204).

Once the mail item enters the mail stream (event 206) of the mail delivery network 110, the item is processed accordingly (event 208). During processing, the unique barcode resident upon the mail item may be detected—i.e., scanned, imaged and/or interpreted—at which time the processing status of the mail item may be stored as event data (event 210). The resulting event data at this point may be aggregated in the data store in association with the barcode; the data capable of being published for data mining purposes or sent to an interested party (event 212). With step 211, a decision is made as to whether or not further processing is required at this point by the delivery network prior to delivery. Steps 210-212 will be repeated for as long as there is additional processing required to be performed upon the mail item within the mail delivery network, with each processing event resulting in additional event data being generated and published. Otherwise, the mail item is formally delivered to the target 240; the delivery event 240 generally proceeded by carrier route sequencing of the mail item with other mails specific to a particular locale to enable efficient physical delivery by a mail carrier.

The response controller 160 operating in connection with the mail owner 100 or preparer 102 queries the progressive data store maintained by the mail delivery network 110 or receives notification of the aggregated event data once available (event 214). Once received, the event data may be maintained by the response controller 160 in a progressive event log in association with the indicated barcode. As such, the event log may be concurrently analyzed by the response controller 160 to determine if any of the actual processing events that occurred as logged correspond to an event based trigger (event 216), the event based trigger representative of an expected or anticipated event When no trigger is detected (actual event data as logged does not match an expected event) (event 218), the response controller 160 simply awaits further event data or queries the mail delivery network's data store for more event data (event 214). When an event trigger is detected (actual event data as logged does match an expected event) (event 218), however, the response controller 160 checks the historical database to determine if any history data 104 pertaining to the target associated with the referenced barcode exists. If so, the historical data is retrieved (event 222) and further analyzed to determine if an adjustment to the intended script to be run need be made based on the history (event 226). For example, if the history data were to indicate a propensity for the target to respond more readily to a text message 120 as opposed to a voice message 122, a script for generating a targeted text message may be selected for execution over another previously intended script type.

In the case where no historical data is available (event 220) with respect to a given target, the intended script associated with the detected event data occurrence is executed accordingly (event 224). For both events 224 and 226, the marketing action invoked or performed by way of script may be a prompt or notification to a marketing channel 100 operating on behalf of the mailer 100 or mail preparer 102, or a direct communication 260 to the target 140. Those skilled in the art will recognize that while the historical data may be useful in adapting script execution relative to a particular target 140, it is optional and does not limit the scope of the techniques presented herein. Also, it will be recognized that the execution of a script may further invoke the execution of other related scripts or programmatic instructions in accord with the marketing action desired. Overall, the marketing action is carried out or invoked by way of an executable marketing script to compliment the delivery of the mail item (event 240) to the target 140.

As shown by the above discussion, aspects of the document processing environment and modules are controlled or implemented by one or more processors/controllers, such as one or more computers or servers. Typically, each such processor/controller is implemented by one or more programmable data processing devices. The hardware elements operating systems and programming languages of such devices are conventional in nature, and it is presumed that those skilled in the art are adequately familiar therewith.

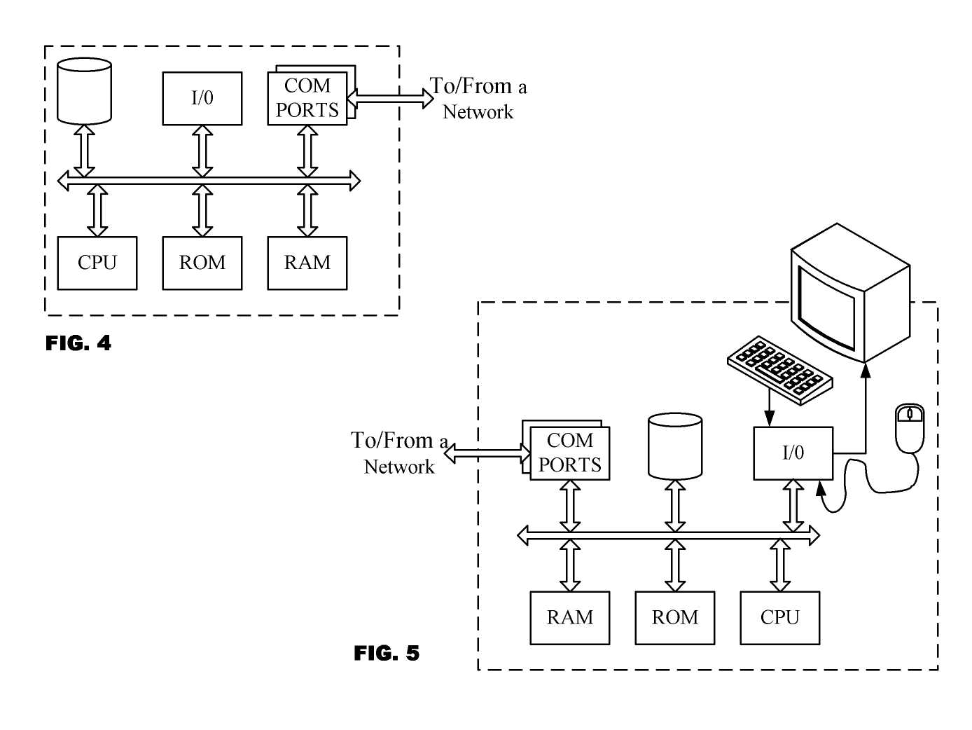

FIGS. 4 and 5 provide functional block diagram illustrations of general purpose computer hardware platforms. FIG. 4 illustrates a network or host computer platform, as may typically be used to implement a server. FIG. 5 depicts a computer with user interface elements, as may be used to implement a personal computer or other type of work station or terminal device, although the computer of FIG. 5 may also act as a server if appropriately programmed. It is believed that those skilled in the art are familiar with the structure, programming and general operation of such computer equipment and as a result the drawings should be self-explanatory.

For example, the response processor/controller 160 may be a PC based implementation of a central control processing system, or may be implemented on a platform configured as a central or host computer or server. Such a system typically contains a central processing unit (CPU), memories and an interconnect bus. The CPU may contain a single microprocessor (e.g. a Pentium microprocessor), or it may contain a plurality of microprocessors for configuring the CPU as a multi-processor system. The memories include a main memory, such as a dynamic random access memory (DRAM) and cache, as well as a read only memory, such as a PROM, an EPROM, a FLASH-EPROM, or the like. The system memories also include one or more mass storage devices such as various disk drives, tape drives, etc.

In operation, the main memory stores at least portions of instructions for execution by the CPU and data for processing in accord with the executed instructions, for example, as uploaded from mass storage. The mass storage may include one or more magnetic disk or tape drives or optical disk drives, for storing data and instructions for use by CPU. For example, at least one mass storage system in the form of a disk drive or tape drive, stores the operating system trigger definitions and various application software as well as data, such as MIDs, histories, job data, target data, scripts, as discussed in detail above. The mass storage within the computer system may also include one or more drives for various portable media, such as a floppy disk, a compact disc read only memory (CD-ROM), or an integrated circuit non-volatile memory adapter (i.e. PC-MCIA adapter) to input and output data and code to and from the computer system.

The system also includes one or more input/output interfaces for communications, shown by way of example as an interface for data communications with one or more other processing systems such as those of the mail preparer 102 and the mail delivery network 110. Although not shown, one or more such interfaces may enable communications via a network, e.g., to enable sending and receiving instructions electronically. The physical communication links may be optical, wired, or wireless.

The computer system may further include appropriate input/output ports for interconnection with a display and a keyboard serving as the respective user interface for the processor/controller. For example, a computer implementation of controller 160 may include a graphics subsystem to drive the output display. The output display, for example, may include a cathode ray tube (CRT) display, or a liquid crystal display (LCD) or other type of display device. Although not shown, a PC type system implementation typically would include a port for connection to a printer. The input control devices for such an implementation of the system would include the keyboard for inputting alphanumeric and other key information. The input control devices for the system may further include a cursor control device (not shown), such as a mouse, a touchpad, a trackball, stylus, or cursor direction keys. The links of the peripherals to the system may be wired connections or use wireless communications.

The computer system runs a variety of applications programs and stores data, enabling one or more interactions via the user interface provided, and/or over a network to implement the desired processing, in this case, including those for processing mail item data and related marketing actions as discussed above.

The components contained in the computer system are those typically found in general purpose computer systems. Although summarized in the discussion above mainly as a PC type implementation, those skilled in the art will recognize that the class of applicable computer systems also encompasses systems used as host computers, servers, workstations, network terminals, and the like. In fact, these components are intended to represent a broad category of such computer components that are well known in the art.

Hence aspects of the techniques discussed herein encompass hardware and programmed equipment for controlling the relevant mail processing and marketing activities as well as software programming, for controlling the relevant functions. A software or program product, which may be referred to as an “article of manufacture” may take the form of code or executable instructions for causing a computer or other programmable equipment to perform the relevant data processing steps regarding mail item tracking or processing and triggering the marketing actions, where the code or instructions are carried by or otherwise embodied in a medium readable by a computer or other machine. Instructions or code for implementing such operations may be in the form of computer instruction in any form (e.g., source code, object code, interpreted code, etc.) stored in or carried by any readable medium.

Such a program article or product therefore takes the form of executable code and/or associated data that is carried on or embodied in a type of machine readable medium. “Storage” type media include any or all of the memory of the computers, processors or the like, or associated modules thereof, such as various semiconductor memories, tape drives, disk drives and the like, which may provide storage at any time for the software programming. All or portions of the software may at times be communicated through the Internet or various other telecommunication networks. Such communications, for example, may enable loading of the software from one computer or processor into another, for example, from a management server or host computer. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the sorting control and attendant mail item tracking based on unique mail item identifier. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

In the detailed description above, numerous specific details are set forth by way of examples in order to provide a thorough understanding of the relevant teachings. However, it should be apparent to those skilled in the art that the present teachings may be practiced without such details. In other instances, well known methods, procedures, components, and software have been described at a relatively high-level, without detail, in order to avoid unnecessarily obscuring aspects of the present teaching

What is claimed is:

1. A method of automatically invoking one or more marketing actions directed toward a mail target, the method comprising:
receiving, at a response controller over a communications network interface, real-time mail stream event data for one or more mail items intended for the mail target, the event data for each respective mail item intended for the target representing one or more events in processing of the respective mail item as it progresses through a mail delivery network prior to delivery to the mail target;
analyzing, by the response controller, the received real-time mail stream event data to detect when a pre-delivery event in the processing of the one or more mail items intended for delivery to the target through a mail delivery network corresponds one of a number of pre-assigned triggering actions; and
issuing a command to execute a marketing action associated with the detected triggering action.

2. The method of claim 1, further comprising executing the marketing action in response to the receipt of the command.

3. The method of claim 2, wherein executing the marketing action comprises executing the marketing action in one or more marketing channels.

4. The method of claim 2, wherein executing the marketing action is selected from the group consisting of transmitting an e-mail message, making a robotic call, transmitting a multimedia messaging message, transmitting a facsimile, generating of a written letter, issuing a machine control message to a mail preparation machine, and executing a salesperson dispatch call.

5. The method of claim 1, further comprising customizing the marketing action in response to customer relationship management data associated with the one or more mail targets.

6. The method of claim 1, further comprising modifying at least one of the pre-assigned triggering actions responsive to customer relationship management data associated with the one or more mail targets.

7. The method of claim 1, further comprising associating one or more triggering actions with one or more mail items using a unique identifier for each mail item to generate the pre-assigned triggering actions and storing the pre-assigned triggering actions in a database in communication with the response controller.

8. The method of claim 1, wherein issuing a command to execute a marketing action comprises issuing a command to begin the execution of a scripted marketing action that is associated with the mail target.

9. The method of claim 1, wherein the analyzing comprises analyzing the received real-time mail stream event data to detect when a final event prior to delivery occurs.

10. The method of claim 1, wherein the real-time mail stream event data comprises at least one of a start-the-clock event, a delivery carrier sequencing event, and an interim processing event.

11. An article of manufacture comprising:
a machine readable storage medium; and
executable program instructions embodied in the machine readable storage medium that when executed by a programmable system in communication with a mail delivery network causes the system to perform functions that automatically invoke one or more marketing actions associated with a mail target, the functions comprising:
receiving, at a response controller over a communications network interface, real time mail stream event data for one or more mail items intended for the mail target, the event data for each respective mail item intended for the target representing one or more events in processing of the respective mail item as it progresses through a mail delivery network prior to delivery to the mail target;
analyzing, by the response controller, the received real-time mail stream event data to detect when a pre-delivery event in the processing of the one or more mail items intended for delivery to the target through a mail delivery network corresponds one of a number of pre-assigned triggering actions; and
issuing a command to execute a marketing action associated with the detected triggering action.

12. The article of manufacture of claim 11, wherein the functions further comprise executing the marketing action in response to the receipt of the command.

13. The article of manufacture of claim 12, wherein executing the marketing action comprises executing the marketing action in one or more marketing channels.

14. The article of manufacture of claim 12, wherein executing the marketing action is selected from the group consisting of transmitting an e-mail message, making a robotic call, transmitting a multimedia messaging message, transmitting a facsimile, generating of a written letter, issuing a machine control message to a mail preparation machine, and executing a salesperson dispatch call.

15. The article of manufacture of claim 11, wherein the functions further comprise customizing the marketing action in response to customer relationship management data associated with the one or more mail targets.

16. The article of manufacture of claim 11, wherein the functions further comprise modifying at least one of the pre-assigned triggering actions responsive to customer relationship management data associated with the one or more mail targets.

17. The article of manufacture of claim 11, wherein the functions further comprise associating one or more triggering actions with one or more mail items to generate the pre-assigned triggering actions and storing the pre-assigned triggering actions in a database in communication with the response controller.

18. The article of manufacture of claim 11, wherein the function of issuing a command to execute a marketing action comprises the function of issuing the command to execute a scripted marketing action that is associated with the mail target.

19. The article of manufacture of claim 11, wherein the function of the analyzing comprises the function of analyzing the received real-time mail stream event data to detect when a final event prior to delivery occurs.

20. The article of manufacture of claim 11, wherein the real-time mail stream event data comprises at least one of a start-the-clock event, a delivery carrier sequencing event, and an interim processing event.

21. A system for automatically invoking one or more marketing actions associated with a mail target, the system comprising:
a database that stores one or more triggering actions, the one or more triggering actions each being associated with one or more mail targets and one or more marketing actions; and
a response controller in communication with the database, the response controller comprising:
a receiver module that receives real-time mail stream event data for each respective mail item intended for the target representing one or more events in processing of the respective mail item as it progresses through a mail delivery network prior to delivery to the mail target; and
a processor that analyzes the received real-time mail stream event data to detect when a pre-delivery event in the processing of a mail item intended for delivery to the target through a mail delivery network corresponds one of a number of pre-assigned triggering actions and issues a command to execute the at least one marketing action associated with a respective triggering action.

22. The system of claim 21, further comprising a customer relationship management database in communication with the response controller, wherein the processor customizes the marketing action in response to customer relationship management data associated with the one or more mail targets.

23. The system of claim 21, further comprising a customer relationship management database in communication with the response controller, wherein the processor modifies the one or more pre-assigned triggering actions stored in the database in response to customer relationship management data associated with the one or more mail targets.

24. The system of claim 22, further comprising an assignment module in communication with the database, the assignment module facilitating the association of the one or more marketing events with the one or more pre-assigned triggering actions.

25. The system of claim 24, wherein the assignment module further facilitates the association of the one or more pre-assigned triggering actions with the mail target.

26. The system of claim 21, wherein the processor executes the marketing action.

27. The system of claim 21, wherein the marketing action is selected from the group consisting of transmitting an e-mail message, making a robotic call, transmitting a multimedia messaging message, transmitting a facsimile, generating of a written letter, issuing a machine control message to a mail preparation machine, and executing a salesperson dispatch call.

28. The system of claim 21, wherein the marketing action comprises executing, by a processor, a script of actions that is associated with the mail target.

29. The system of claim 21, wherein the pre-delivery event comprises a final event prior to delivery of the mail item to the target.

30. The system of claim 21, wherein the real-time mail stream event data comprises at least one of a start-the-clock event, a delivery carrier sequencing event, and an interim processing event.
